(19) United States
(12) Patent Application Publication
(10) Pub. No.: US 2024/0386162 A1
(43) Pub. Date: Nov. 21, 2024

(54) METHOD AND DEVICE FOR PROVIDING A RECOMMENDER SYSTEM

(71) Applicant: Siemens Industry Software Inc., Plano, TX (US)

(72) Inventors: Mitchell Joblin, Surrey (CA); Marcel Hildebrandt, München (DE); Serghei Mogoreanu, München (DE); Chandra Sekhar Akella, Madison, AL (US)

(21) Appl. No.: 18/714,777

(22) PCT Filed: Dec. 3, 2021
(86) PCT No.: PCT/IB2021/061279

§ 371 Date: May 30, 2024

(51) Int. Cl. G06F 30/20; G06F 111/20

(52) U.S. Cl. CPC G06F 30/20; G06F 2111/20

(57) ABSTRACT

A computer implemented method for providing a recommender system for a design process of a complex system is provided, wherein the recommender system is shared by a plurality of users, wherein the complex system includes a plurality of connectable components and is designed in a design process by a sequence of design steps wherein in each design step a partial design is created until a completed design is obtained, wherein a partial design of one step and a partial design of a subsequent step differ in a design difference reflecting a difference in at least one element including a component or/and connection of the components, and wherein the shared recommender system provides at each design step a prediction of the subsequent design difference.

### CROSS-REFERENCE TO RELATED APPLICATIONS

This application is a national stage of PCT Application No. PCT/IB2021/061279, having a filing date of Dec. 3, 2021, the entire contents of which are hereby incorporated by reference.

### FIELD OF TECHNOLOGY

The following relates to a computer implemented method for providing a recommender system for a design process. The following further relates to a corresponding computer program and recommendation device.

### BACKGROUND

For industrial applications, engineers often need to design a complex system or engineering project which comprises a multitude of interconnected components. The design of such a system is usually performed in engineering tools, which are run on a computer, and can be described as an iterative process of identifying components whose interplay will fulfill the functional requirements arising from the intended application of the overall system, introducing the identified components into the project, and connecting them to one another such that the resulting interconnected components allow the intended real-world application.

Due to the sheer number of available components, as well as the ways of connecting them, this process is time-consuming, requires technical expertise, domain knowledge and effort to be completed correctly. One way of supporting the engineer in this process is to integrate into the engineering tool a recommender system that would suggest appropriate and compatible components to be added into the engineering project.

The recommendation or recommender system can be realized by using a model based on a neural network architecture, which has been trained with data from design processes. In a such created model, which predicts the next component(s) or connection(s) to be added, the prediction or recommendation is data-driven and relies on data available for the training.

Thus, it would benefit significantly by learning from the data that is generated by a plurality of its users.

However, data privacy concerns prevent users from agreeing to share their data or usage patterns with engineering tool providers, i.e., people in charge of designing and maintaining the recommendation system or other user groups, e.g., from a different company.

Currently, many engineering tools suffer from poor user experience as a result of e.g., overwhelming users with menu items that do not sufficiently capture the user's context, e.g., the current project state, or the user's preferences, e.g., desired order of operations when presenting menu items.

Given the complexity of engineering domains, the most suitable type of recommender system relies on the concept of collaborative filtering, which requires data regarding the engineering tools usage patterns. Collaborative filtering is a technique by which an unknown preference of a single user is deduced from known preferences (“ratings”) a group of users, who has an overlap in ratings with the single user. Hence, there is no personalizing, but just a guess about the user's preferences.

Still, for a satisfying performance, personalizing the recommendations according to user preferences is desirable. However, for the personalizing data of the individual user is required. But engineering recommender systems must learn to recommend the appropriate components among hundreds of thousands of items and to understand the complex relationship between conditions. To meet this requirement, a lot of training data is necessary, which makes it infeasible to train a model individually per user.

A solution leading to a satisfying recommender system requires a collective learning from many users. As they are likely to be spread across multiple organizational units and companies, however, privacy concerns eliminate any possibility to centralize the multi-user training data and apply standing machine learning training procedures.

### SUMMARY

An aspect relates to a possibility to improve recommender system usable for a plurality of users. Further, it is an aspect to overcome the disadvantages of individual training, collaborative filtering or a sharing of training data in the context of recommender systems.

According to a first aspect, embodiments of the invention relate to a computer implemented method for providing a recommender system.

The recommender system is used for a design process and shared between a number of users.

In the design process, which is, e.g., performed by using an engineering tool, a complex system, e.g., an electronic component or a hybrid vehicle, is created in a sequence of design steps. A complex system can be described by a plurality of components, e.g., a memory chip or a processor, which are at least partly interconnected, e.g., electrically or inductively.

In a design step, an intermediate or partial design is achieved by adding one or more elements to the partial design of the previous step. An element comprises at least one component or at least one connection or both. The recommender system predicts the design difference or difference in elements between one design step and a subsequent design step.

According to an embodiment, this is provided to the user of the recommender system as a context sensitive menu. If the prediction of the recommender system is good, i.e., technically reasonable as well as fitting to the user's requirements, this enhances the design process in view of speed and quality because only relevant menu items are proposed at a certain stage.

To facilitate good predictions by the recommender system, the recommender system is provided by a computer implemented method with the following steps: On a central server, e.g., facilities of an engineering tool provider or cloud services, a global or shared recommender system is provided. It is global or shared in the respect that it is intended for a plurality of users.

This shared recommender system encodes partial designs, which are, e.g., available in the form of knowledge graphs comprising nodes representing components and links representing connections between components. The encoding is done, e.g., by using a graph neural network architecture and the result of the encoding is information about the components and their interconnections.

The global recommender system further provides predictions of the subsequent design difference and for this it has been trained with training data that have been shared. These training data affect the parameters of the global or shared recommender system. They are denoted as “shared training data” in the respect that the plurality of users might access these data, e.g., for control purposes and the creator of the data, e.g., the engineering tool provider has no privacy concerns regarding this sharing.

The parameters, e.g., the weights used in the graph neural network architecture of the shared recommender system or parameters of the graph neural network architecture are transmitted to a user or client. The users initialize their version of the shared recommender system using these transmitted parameters.

For example, the users have received their version of the shared recommender system by transmission from the central server to local facilities or it is provided to them as a service.

Users may perform a user specific training with their own, specific data to adapt the shared recommender system to their needs in order to obtain a personalized recommender system. Some of the users transmit gradient information obtained in this user specific training to the central server. The gradient information provides information about the evolvement of the parameters, e.g., the changes in the used weights to reduce the error between prediction of the design difference and actually chosen design difference, in the user specific training.

Providing gradient information from which no conclusions can be made to the used training data has the advantage that the shared model can be updated by using trainings performed by a multitude of users without the need of sharing training data between these users which can raise privacy concerns.

At the central server this gradient information is used to update the shared recommender model's parameters. This updated shared recommender system is provided as new shared recommender system.

According to an embodiment these updated parameters are again provided to at least some of the users.

According to a further embodiment the shared recommender system comprises an encoder network which in particular comprises a graph neural network. The encoder network encodes the information relating to the components of the complex system and connections between them. The shared recommender system further comprises a decoder network which derives from this information a probability that at a certain design step in the design of the complex system a certain design difference is chosen.

This has the advantage that by this separation at the user side only decoder parameters need to be adjusted, as the underlying encoded information, i.e., components and their relations, is the same.

According to further aspect, embodiments of the invention relate to a computer program product (non-transitory computer readable storage medium having instructions, which when executed by a processor, perform actions) by which the described method can be performed when run on a computer.

According to a further aspect, embodiments of the invention relate to a recommendation device on which the computer program is stored or/and provided. For example, this recommendation device can be connected by an interface, e.g., an API to the engineering tool for the design of the complex system.

### BRIEF DESCRIPTION

Some of the embodiments will be described in detail, with references to the following Figures, wherein like designations denote like members, wherein:

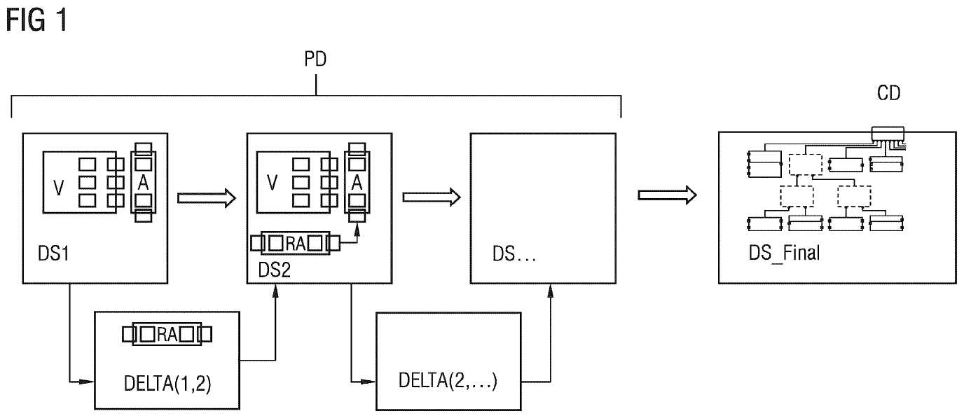

FIG. 1 shows an example of a system design process performed in an engineering tool, where a system is constructed over the course of a sequence of design steps. The design process is decomposed into a set of design deltas that define the operations that correspond to transforming the previous step's design into the subsequent step's design:

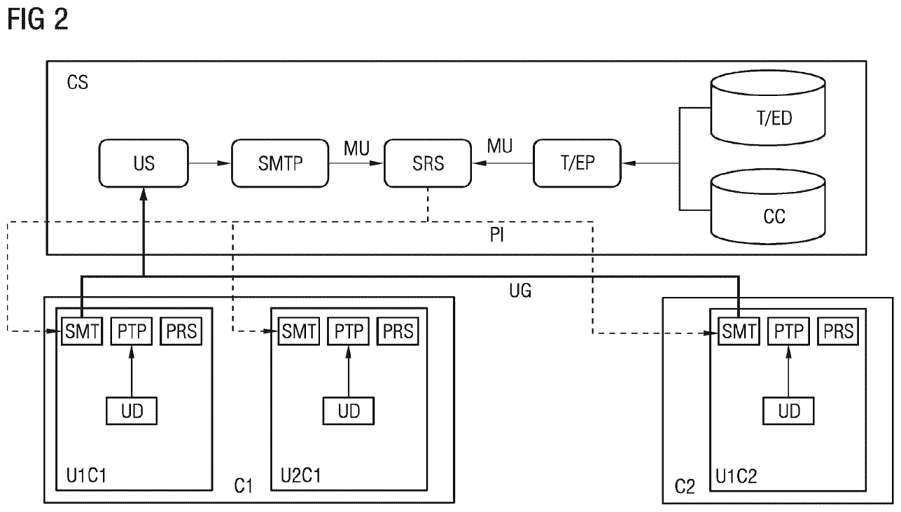

FIG. 2 shows a training procedure and information flow between a global, shared recommender system and personalized recommender systems of individual users: and

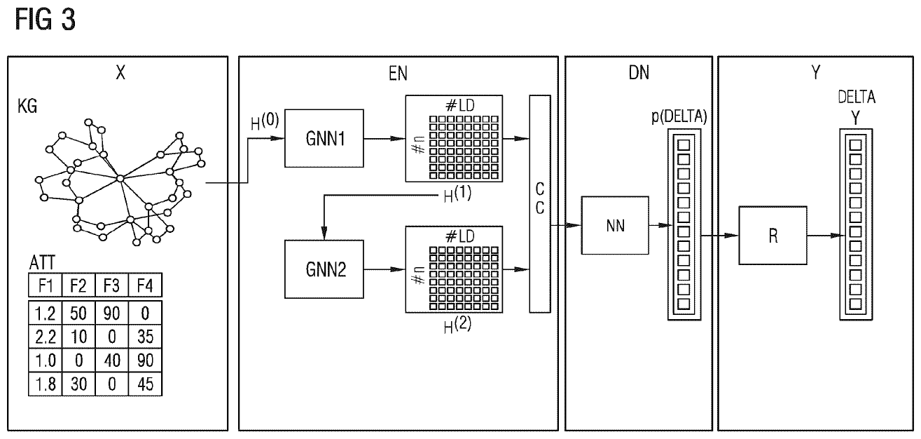

FIG. 3 shows an exemplary architecture of a recommender system model.

### DETAILED DESCRIPTION

It is one aspect of embodiments of the invention to provide recommender systems capable of guiding an engineer toward the next component they need during the design of a system. For example, the recommender system is implemented in an engineering tool, for which in the design process a context dependent menu is shown, which proposes which element should be added next.

In this context, a system can be anything ranging from a printed circuit board to an autonomous vehicle. These complex systems are comprised of several interconnectable components each with a set of technical features.

For example, for a memory module, these technical features may include its clock frequency, write cycle time, access time and required voltage supply and the connection may be realized across different bus systems.

Software suites, i.e., collections of software available to support the design or and configuration of complex systems, are offered for various applications such as construction tasks, industry automation designs or chemistry. Examples at Siemens are e.g., SimCenter™ or TIA (totally integrated automation) portal. These tools can be used to create a wide variety of systems ranging from hybrid vehicles and quadcopters to factory automation systems or electronic components or chips. For an efficient engineering or design process it is important that these tools provide the support a specific engineer needs at a specific stage for a specific project.

The engineering or design process is carried out by sequentially selecting a component and adding it to the already existing system design. Each component may be connected to a number of other components by different link types, e.g., mechanical, electrical, via a specific bus etc.

The recommender system is made aware of the current project state and provides, e.g., in a context sensitive menu, a ranked list of suitable components or connections to choose as the next item. The ranking reflects the likelihood of selection where the highest ranked items are the most likely to be selected, i.e., added to the existing system design in a next step.

Each engineer has his own preferences. This may be reflected in the order of operations. For example, one user may prefer to begin with the most central components, while another may wish to start with peripheral components. When it comes to the connections between components, one user may prefer to select all components first and then make the appropriate connections while another user may prefer to select a single component and then subsequently establish all necessary links to this component. The recommender system must be capable of learning across multiple users while also adapting to the personal preferences of each engineer.

According to an embodiment of the invention, the following components are used for the implementation of the proposed recommender system:
A global or shared recommender system model
A set of personalized recommender system models
A training process for updating the global system model parameters
A training process for personalizing the global models to user preferences.
Sampling procedure to select clients for the shared model update.

### Design Process using a Recommender System

In FIG. 1 an example of a design process for a system is shown that is performed with the help of an engineering tool.

A system is a complex object comprising a variety of connectable components which have to be used and combined and connected in such a way as to fulfil requirements set for the complex object, e.g., a hybrid car or an electronic component.

A system is constructed over the course of a sequence of design steps starting from an initial combination. The design process can be decomposed into a set of design differences that define the operations that correspond to transforming the previous step's design into the subsequent step's design.

In FIG. 1 in a first design step DSI there is only the component “vehicle” V having properties like mass, number of front or rear tires denoted by the squares inside the and different ports to be mechanically, electrically or otherwise connected to a further component denoted by the squares at the boundary. Further there is the component axles A which can be connected to a front or rear axis.

Going from the first design step DS1 to a second design step DS2, one or more elements or connections DELTA(1,2), which is also referred to as design difference or design delta, are added, in the depicted example the new element rear axle RA is added and is connected to the element axles A. From the second design step DS2 a further design difference DELTA (2, . . . ) is added to obtain a subsequent design.

All these intermediary designs, before a completed design CD is achieved are referred to as partial designs PD.

In the course of the development process, in each design step elements are added and connected to the partial designs PD, until after a sequence of design steps DS . . . a completed design CD is obtained in a final design step DS_Final.

The completed design CD is used for the realization of the complex object, if the requirements for the complex object, e.g., a certain performance of the electric component or part thereof, are met.

Hence, by the term “completed design” CD a completed system architecture, e.g., a complete hybrid car or a complete electronic component is comprised as well as an intermediary design, which is forwarded to another user, company etc., e.g. to be processed further.

The objective of a recommender system is to predict with a sufficient accuracy the probable next design differences DELTA. This means it should learn from the context, i.e., current design step, and user preferences to predict the subsequent design difference DELTA, i.e., components and connections to be added.

### Architecture of The Recommender System

In FIG. 3 a high-level schematic view of the architecture of a recommender system or model is depicted. As input data X partial designs PD and completed designs are used.

For the training all possible partial designs PD and complete designs CD consisting of one or more elements in the component catalogue CC are used as input data X. As output data Y a ranking of the elements to be added or design differences DELTA is to be obtained, i.e., for each design differences the respective probability.

When the recommender system has been trained and is being used, then the input data X would be a specific partial design PD and the output data would be a ranking of design differences DELTA to be added to this specific partial design.

As an example, for the input data in FIG. 3 the complete design CD of a hybrid vehicle V is depicted as a knowledge graph KG which optionally contains attributes ATT to individual nodes. The hybrid vehicle V is represented by the central node. By the knowledge graph KG which comprises nodes representing elements and links representing connections between elements and optionally the attributes ATT a specific system design of a complex system can be described in permutation invariant way suitable to be used by graph neural networks.

In the encoder network EN, a representation of the nodes of the knowledge graph KG and their relations to neighbored nodes is obtained by feeding the input data X in graph neural network. First, the input data X are fed into a first graph neural network GNN1.

The input data X, which are also denoted as H⁽⁰⁾, is a representation of the node features and the link structure of the data architecture and can be described by an adjacency matrix Ã.

Thus, H⁽⁰⁾ contains features or properties, e.g. motor properties or available connection types, solely referring to a specific node. In other words, everything relevant for the identity of a specific node in the given complex system is contained.

For example, these data may represent a motor with its weight, electrical or mechanical connection possibilities.

In the first graph neural network GNN1, features of one hop distant nodes are encoded into the representation of a specific node.

By re-iterating this process, more and more distant information is considered for the encoding of a specific node.

The output of the first graph neural network GNN1, which is a matrix H⁽¹⁾ with dimensions depending on the number of nodes #n of the design and the number of latent dimensions #LD of the first graph neural network GNN1 serves as input for a second graph neural network GNN2.

As said above, the values of matrix H⁽¹⁾ reflect first order correlations between two nodes, i.e. with one edge in between. Thus, in addition to node features, first order correlations are encoded in this matrix H⁽¹⁾. As explained before, a first order correlation has an edge leading directly from source node to target node, a second order correlation has an edge leading from the source node via a first edge to an intermittent code and via a second edge to the target node, etc.

By using H⁽¹⁾ as input for the second graph neural network GNN2, second order correlations between two nodes, i.e. the nodes having a node in between, thus via two edges are considered in the output H⁽²⁾ which is a matrix with dimensions number of nodes #n* and number #LD of latent dimensions of the graph convolutional neural network. H⁽²⁾ encodes node features and information from nodes one and two hops distant from the considered node.

Experiments have shown that considering first order and second order relations, i.e., considering relations with nodes one hop or two hops away, lead to good results, i.e., the indicators derived reflect the reality very well. Depending on the data architecture, in other embodiments also higher order correlations are advantageous. The usefulness depends, e.g., on the strength of the correlation between the nodes or the number of connections between a node and other nodes, because if going to higher order, more distant relations are being examined whereas information regarding the node features and from closer nodes is being smoothed out.

Regarding the architecture, the graph neural networks may comprise a single convolutional layer. Alternatively, more complex operations may be possible, e.g., also including other layers, e.g., further convolutional layers or other types of layers. First graph neural network GNN1 and second graph neural network may differ from each other in architecture or/and training.

### Standard Graph Convolution

According to an advantageous embodiment the convolutional operator used in any of first or second graph neural network GNN1, GNN2 is

$${H}^{( l + 1 )} = σ ( {\tilde{D}}^{- 1 / 2} Ã {\tilde{D}}^{- 1 / 2} {H}^{( l )} {W}^{( l )} )$$

wherein H is the representation of the nodes. 1 is a running variable denoting the number of latent dimensions in the graph convolutional neural network or the convolutional layer of the graph convolutional network. For 1=0, H ⁽⁰⁾ represents node features, e.g. the type which might be e.g. “component” or the number and type of ports. H is iteratively updated and then represents for values 1>0 also relations between the nodes.

σ is a sigmoid function which is used as an activation function of the GNN. The matrix \tilde{D}⁻¹ is used for normalization and can be derived from the input and a diagonal matrix.

Ã is a matrix reflecting the topology of the data structure, e.g., the complete design CD or partial design PD. For example, Ã is an adjacency matrix which describes the connections between one node and another node for all nodes in the graphical representation, hence it represents essentially the link structure. W^{(l)} is a parameter or weight denoting the strength of a connection between units in the neural network. The advantage of this convolutional operator is its basic form. The aggregation, i.e., gathering of information relevant for one specific node, is based on mean values.

Alternatively, other convolutional operators can be used that are tailored for a specific problem, e.g., design process for an electronic component or for a chemical compound.

### Concatenation

The node representations H⁽¹⁾ and H⁽²⁾ thus represent the structural identity of each node and its surroundings by encoding adjacency information. The node representations H⁽¹⁾ and H⁽²⁾ are concatenated CC and thus concatenated data are obtained.

For example, the two matrices H⁽¹⁾ and H⁽²⁾ are stacked, the concatenated data is then a matrix having the number of columns of H⁽¹⁾ plus the number of columns of H⁽²⁾. So, the concatenated data's dimension depends on the original number of nodes in the data architecture, the number of latent dimensions of the first graph neural network GNN1 and the number of dimensions of the second graph neural network GNN2, and up to which order correlations are considered, i.e., how many matrixes H⁽¹⁾ are appended.

Using the combined data subsequently a decoding takes place in the decoder neural network DN.

### Decoding

In the decoder neural network DN from the node encodings for each design difference DELTA a respective probability is extracted by using a neural network NN.

The decoder network could be of several types. One example would be a dot product or scalar product decoder where each partial design is scored against all components in the catalog using the dot product operator or scalar product followed by a softmax function to obtain probabilities. By a softmax function a vector having numbers as entries is converted to a vector having probabilities as entries. For example, it can be realized by using a normalized exponential function.

The probability assigned to a design difference DELTA reflects how probable it is, that the specific design difference DELTA is added to a specific partial design PD. The probability can be seen as a function of the partial design PD and the design difference DELTA.

### Ranking

By sorting or ranking R for each partial design PD the design differences DELTA according to their respective probability, for each partial design DELTA as output Y a group of design differences DELTA which are most likely to be included in the next design step can be determined.

Thus, in the context dependent menu of the engineering tool, only the most relevant design differences can be displayed which makes the design process more efficient and helps to avoid errors.

To sum up, the exemplary architecture of the recommender system comprises an encoder network into which data in form of graphs are fed end encoded, a decoder network which extracts from the encoded information a probability and a ranking entity which ranks the design differences delta according to their probability. The exemplary architecture of the encoder network comprises a

[symbol]

Training procedure and information flow between global and personalized recommender systems

As said above, it is one aspect of embodiments of the invention to provide a recommender system which proposes for a specific design step the elements most likely to be added in a subsequent design step. Therefore, the recommender system should learn from the context, i.e., the current design partial design PD, and user preferences to predict elements of the subsequent design delta.

To achieve this, a combination of central training and individual training is proposed which is described with respect to FIG. 2.

In FIG. 2 information flow between a global recommender system and several personalized recommender systems, derived from the global recommender system, is depicted.

On a centralized server CS training and evaluation data T/ED are deployed. Training data are used to train a model, the evaluation or validation data are data removed from the set of training data in order to test with them the model's hyperparameters. A hyperparameter is a parameter whose value cannot be estimated from the data provided to the model but is used for the control of the learning process. It is, e.g., a learning rate for training a neural network.

Further on the centralized server CS a component catalogue CC is deployed. The component catalogue comprises the elements which can be added during the design process, i.e., for arbitrary partial designs PD.

For example, this component catalog CC is hosted on the server side and contains information about any item that can be recommended to the user including the technical properties (e.g., resistance of resistor components, power rating for any electrical component etc.).

According to an embodiment, the items of the component catalog CC are transmitted to the users together with the shared recommender model or an update thereof.

These data, training and evaluation data T/ED and component catalogue CC, enter the training and evaluation procedure for the global recommender model. A model update MU is performed after the training in which original parameters are replaced by parameters derived from the training process.

The global recommender system model SRS must be capable of encoding the partial designs PD illustrated in FIG. 1 and ranking items or elements or design differences DELTA to be added accordingly. As system designs can be appropriately described by a graph, a graph neural network or any graph learning-based approach is suitable.

The training and evaluation data T/ED used for training and evaluation procedure T/EP of the shared recommender system SRS are data that can be shared between different users and companies, e.g., because the respective generator of the data agrees to that or the data have been created by a simulation, were generated for tutorial purposes etc., i.e., the data contained on the server side are not considered to be user sensitive.

The global recommender system or model SRS learns from the experience of all users without being exposed directly to the user data by federated transfer learning which is described in the following:

The parameters of the global or shared recommender model SRS are transmitted to each user using the shared recommender model SRS for parameter initialization PI. The user initializes the shared recommender model, i.e., sets the parameters to the proposed values. The parameter can be e.g., the weights of individual neurons.

The thus initialized shared recommender system SRS is used as a starting point for the personalization of the shared recommender system SRS by use of user specific training data in a shared model training SMT.

### Personalized Training Procedure

To personalize the parameters of the shared recommender system (SRS) to each user's desired working mode, a personalizing training procedure PTP is executed based on each user's data UD. The personalizing training procedure PTP adapts the initialized parameters taken from the shared recommender system SRS according to the client's usage data UD which are taken e.g., from his previous design processes in order to obtain a personalized recommender system PRS. Thus, the general strategy and hyperparameters of this training procedure differ from that of the training procedure for the shared recommender system SRS as the goal here is to optimize the shared recommender system's parameters according to the user's personal usage data UD such that the proposed design difference DELTA at a design step meets the user's needs and preferences best.

To achieve an optimal performance across all users, in contrast, is not an objective of the personalizing training procedure PTP.

By the personalizing training procedure PTP a personalized recommender model is produced by updating only the decoder network DN model parameters, e.g., the weights used in this neural network NN, while keeping the encoder parameters fixed, e.g., the weights of the first neural network GNN1 and the second neural network GNN2. Thus, the probabilities of design differences DELTA are adapted as this varies for individual users and hence the ranking of the proposed design differences is changed accordingly.

### Improvement of Shared Recommender System by Individual Usage-Server-side Shared Model Training

The shared recommender model SRS is updated according to what is learned by each client's usage data UD. The clients may be a first user in a first company UIC1, a second user in the first company U2C1, a first user in a second company UIC2, etc. While users within the first company might want to use together data generated by them, an exchange of data between different companies is unlikely.

During the personalized training process PTP a gradient of the parameters of the decoding network DN is calculated. A gradient describes the change in all weights with respect to a change in error. As error the difference between the true result and the result yᵢ obtained by the personalized recommender model for the input/training data set xᵢ is denoted.

The computed user gradients UG are transmitted to the central server CS as shown in FIG. 2. The usage data UD itself is never passed to the global recommender model training, only the gradient information. Therefore, the user's privacy is maintained. Further, the amount of transmitted data is reduced if transmitting only a gradient instead of a set of training data created by the user. Even further, the update of the shared recommender model using the gradients requires less calculation effort than using a new set of training data.

On the side of the central server CS, the user gradient information UG transmitted by each client or user is used to form in a shared model training procedure SMTP an update to the model parameters of the shared recommender model. A recommender loss function is described by Lᵢ (w,xᵢ,yᵢ), wherein w is the set of weights used in the personalized recommender model, for example a matrix wⱼₖ, xᵢ is the set of input data, i.e. the intermediary or partial designs PD, yᵢ is the set of results, i.e. the proposed elements or design differences DELTA. The recommender loss function indicates the error produced by the set of model parameters w and training example xᵢ,yᵢ. The recommender loss function can be calculated, e.g., by use of the binary cross entropy. The total loss over all examples is defined as

$$L = \frac{1}{n} {\sum }_{i = 1}^{n} {L}_{i}$$

where n denotes the number of training examples.

The shared recommender model parameter update using gradient descent is defined as

$${w}_{t + 1} = {w}_{t} - γ ∇ L$$

where ∇L denotes the gradient of the loss function. γ is a parameter, that denotes the learning rate or step width. In words, the weights are changed between step t and step t+1 depending on the size of the scalar product of parameter γ and the gradient of the loss function. This gradient is in a multidimensional space, the derivative described by the gradient is taken of the loss function with respect to the model parameters. As an example, one entry could be the derivative to a certain a weight wⱼₖ, dL/d wⱼₖ. Thus, e.g., local minima of the loss function can be found, and an appropriate set of parameters can be determined.

For an individual user or client, a gradient ∇L_{c} indicates the gradient computed by a single client c.

To update the shared recommender system or model SRS parameters, an average is taken over all considered clients

$${w}_{t + 1} = {w}_{t} - γ {\sum }_{c}^{} \frac{{N}_{c}}{N} ∇ {L}_{c}$$

where N_{c} denotes the number of training samples at client c and N denotes the total number of training examples across all considered clients. The weighted averaging allows users or clients with more training examples to influence the update more heavily.

According to another embodiment, the weighting can be made differently, e.g., weights are assigned to a certain user or user group depending on their e.g. experience, quality of their designs, time the engineering tool has been used etc.

Depending on the embodiment either all or a subset of clients is considered. The advantage of considering all clients is to obtain a high number of gradients.

### Selection of Clients Contributing to Update

According to another embodiment, each update to the shared recommender model or system SRS is performed by taking gradient information only from a subset of clients.

Thus, the quantity of transmitted data and calculation effort for the update can be reduced in addition to reduce efforts on the client's side. The choice of the subset or user sampling US has to be done such that the update of the weights based on the single user's gradient information still improves the shared recommender system SRS.

In the case that many clients for the specific development tool will exist within the same organization, many clients may contain very similar system designs and large systems are often co-developed by teams of engineers causing designs to be shared. The potential lack of variation in the data across some clients makes it inefficient to learn from all clients.

To gather information if the gradient information obtained by the local training of a client would impact the parameters of the shared recommender model SRS delivered to all customers, the shared recommender model SRS, before a personalization, is used at each client to compute performance metrics on the local client data.

By the performance metrics an accuracy of the prediction is measured, i.e., how accurate the prediction of a design difference is for the specific user or client, in other words the size of the error for predictions for the specific client.

According to an embodiment, the error E is calculated as sum over the errors for predictions for any partial design PDᵢ

$${E}_{} = {\sum }_{i}^{} {E}_{i}$$

These performance metrics are transmitted to the server and used in a sampling approach. Clients that are mostly likely to possess gradient information that will boost the performance of the shared model, e.g., decrease the average error for any user, are more likely to be sampled.

For example, these are clients with bad performance metrics, i.e., clients for who the predictions of the personalized recommender model do not work satisfyingly.

An alternative approach is to train a reinforcement learning agent to choose the clients. According to an embodiment a reward is based on the performance metrics.

Alternatively, or additionally, a neural network could also be trained to estimate the expected improved improvement of the shared recommender model when using the client data. This estimation procedure is and can be executed on the client side only, thus preserving data privacy.

Tests have shown that the application of a recommender system according to any of the described embodiments could reduce the error rate in design and reduce the time needed for completing a design.

In the context of this application, the design produced by using a recommender system is applied to manufacture e.g., a new hybrid car, an electronic component etc. or parts thereof, if it suffices the requirements for the respective product, e.g., in view of functionality. Thus, the efforts in manufacturing can be reduced because the design obtained by the engineering tool can be analyzed in the relevant aspects beforehand.

The term “recommendation device” may refer to a computer on which the instructions can be performed.

The term “computer” may refer to a local processing unit, on which the client uses the engineering tool for designing purposes, as well as to a distributed set of processing units or services rented from a cloud provider. Thus, the term “computer” covers any electronic device with data processing properties, e.g., personal computers, servers, clients, embedded systems, programmable logic controllers (PLCs), handheld computer systems, pocket PC devices, mobile radio devices, smart phones, devices or any other communication devices that can process data with computer support, processors and other electronic devices for data processing. Computers may comprise one or more processors and memory units and may be part of a computer system. Further, the term computer system includes general purpose as well as special purpose data processing machines, routers, bridges, switches, and the like, that are standalone, adjunct or embedded.

The term “user” may in particular refer to an individual, a group of individuals or a company.

In the foregoing description, various aspects of embodiments of the present invention have been described. However, it will be understood by those skilled in the conventional art that embodiments of the present invention may be practiced with only some or all aspects of embodiments of the present invention. For purposes of explanation, specific configurations are set forth in order to provide a thorough understanding of embodiments of the present invention.

However, it will also be apparent to those skilled in the conventional art that embodiments of the present invention may be practiced without these specific details.

Parts of the description will be presented in terms of operations performed by a computer system, using terms such as data, state, link, fault, packet, and the like, consistent with the manner commonly employed by those skilled in the conventional art to convey the substance of their work to others skilled in the conventional art. As is well understood by those skilled in the conventional art, these quantities take the form of electrical, magnetic, or optical signals capable of being stored, transferred, combined, and otherwise manipulated through mechanical and electrical components of the computer system;

Additionally, various operations have been described as multiple discrete steps in turn in a manner that is helpful to understand embodiments of the present invention. However, the order of description should not be construed as to imply that these operations are necessarily order dependent, in particular, the order of their presentation.

Reference in the specification to “one embodiment” or “an embodiment” means that a particular feature, structure, or characteristic described in connection with the embodiment is included in at least one embodiment of the invention.

The appearances of the phrase “in one embodiment” in various places in the specification are not necessarily all referring to the same embodiment.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer implemented method for providing a recommender system for a design process of a complex system,
wherein the recommender system is shared by a plurality of users,
wherein the complex system comprises a plurality of connectable components and is configured in a design process by a sequence of design steps,
wherein in each design step a partial design is created until a completed design is obtained,
wherein a partial design of one step and a partial design of a subsequent step differ in a design difference reflecting a difference in at least one element comprising a component or/and connection between components,
and wherein the shared recommender system provides at each design step a prediction of the subsequent design difference,
the method comprising:
a) providing, on a centralized server, a shared recommender system which encodes partial designs and provides predictions of the subsequent design difference,
the shared recommender system being trained by shared training data;
b) transmitting parameters of the shared recommender system from the central server to a plurality of users for initializing a user's version of the shared recommender system;
c) receiving, on the central server, gradient information from a subset of users, the gradient information being obtained by a user specific training of the user's version of the shared recommender system with user specific training data to obtain a personalized recommender system, the gradient information indicating an evolvement of an error of the predictions in dependance on the applied parameters;
d) updating, at the central server, at least one of the shared recommender system's parameters using the received the gradient information.

2. The method according to claim 1 comprising:
e) transmitting, updated parameters of the shared recommender system from the central server to a plurality of users.

3. The method according to claim 1, wherein the shared training data used on the central server can be shared between different users or/and the user specific training data cannot be shared between all different users.

4. The method according to claim 1, wherein the shared recommender system comprises an encoder network which encodes information relating to the components and connections of the complex system and
a decoder network which extracts from the information a probability that at a certain design step a certain design difference is chosen and wherein the training at the central server comprises a training of the encoder network and the decoder network.

5. The method according to the claim 4, wherein in the user specific training only parameters of the decoder network are trained, and the gradient information is derived therefrom.

6. The method according to claim 4, wherein for the updating in step d) only the decoder network parameters are updated while parameters of the encoder network, which is formed by a graph neural network, are fixed.

7. The method according to claim 1 with an additional step b1) wherein a performance metric denoting information regarding the use of the personalized recommender system by a specific user is received from users and wherein in step c) the subset of users for which gradient information is received is determined on a basis of the performance metric which depends on at least one of:
a variation of the designs of a complex system between individual users in a group of users;
a number of used training samples of a user;
an accuracy of the prediction of the shared recommender system after initialization and before the personalized training procedure;
an accuracy of the prediction of the personalized recommender system after the personalized training procedure.

8. The method according to claim 7, wherein a reinforcement learning agent is trained to select the subset of users for which gradient information is sent, wherein a reward in the training procedure is based on the performance metric.

9. The method according to claim 1, wherein the gradient information is calculated based on a loss function L which is formed as a sum over the individual loss functions Lᵢ
$$L = \frac{1}{n} {\sum }_{i = 1}^{n} {L}_{i}$$
wherein n is the number of training data sets and wherein Lᵢ (w,xᵢ,yᵢ) is the loss function for a specific set of training data xᵢ,yᵢ, wherein xᵢ is a specific partial design and yᵢ is the predicted design difference for this partial design and w are the used weights.

10. The method according to the claim 9, wherein the update of the shared recommender system parameter, the weights, uses gradient descent and is defined as
$${w}_{t + 1} = {w}_{t} - γ ∇ L$$
wherein wₜ₊₁ and wₜ is the weight at trainings step t+1 and t, γ is a parameter denoting a learning rate and ∇L is the gradient of the loss function.

11. The method according to claim 2, wherein parameters of the shared recommendation system are updated taking an average over the subset of users for which gradient information is received by
$${w}_{t + 1} = {w}_{t} - γ {\sum }_{c}^{} \frac{{N}_{c}}{N} ∇ {L}_{c}$$
wherein N_{c} denotes the number of training samples at a specific user and L_{c} the loss function of the specific user and N is the overall number of training samples.

12. The method according to claim 1, wherein the gradient information is formed by ∇L wherein the loss function L is determined by use of the binary cross entropy and wherein the loss function L can be determined as a function of loss functions for an individual training set i or/and an individual user c.

13. The method according to claim 1, wherein a component catalogue listing components and connections, is deployed on the centralized server and transmitted to the plurality of users.

14. A computer progrm product, comprising a computer readable hardware storge device having computer readable program code stored therein, said program code executable by a processor of a computer sytem to implement a method according to claim 1.

15. A recommendation device, wherein the recommendation device stores or/and provides the computer program according to claim 14, the recommendation device having a communication interface for an engineering tool for the design of a complex system.
